(19) United States
(12) Patent Application Publication
(10) Pub. No.: US 2003/0124271 A1
(43) Pub. Date: Jul. 3, 2003

(54) Vehicle trim panel/radiator element system

(76) Inventor: Rajendran S. Michael, Granville, OH (US)

Correspondence Address: OWENS CORNING, 2790 COLUMBUS ROAD, GRANVILLE, OH, 43023, US

(21) Appl. No.: 10/039,025

(22) Filed: Dec. 31, 2001

(51) Int. Cl. B32B 3/10

(52) U.S. Cl. 428/31; 428/131

(57) ABSTRACT

A vehicle trim panel/radiator element combination is provided comprising a first substrate having at least one rib and at least one opening adjacent to the rib. The first substrate defines a vehicle interior trim panel. A multi-layer second substrate is located so as to extend at least partially over the opening, is secured to the first substrate rib, and defines a speaker radiator element. Further provided is a vehicle trim panel/radiator element integral unit comprising a multi-layer substrate. The substrate is formed so as to have a first region compressed to a first thickness and a second region having a second thickness, which is greater than the first thickness. The first region defines a speaker radiator element.

### TECHNICAL FIELD AND INDUSTRIAL APPLICABILITY OF THE INVENTION

The present invention relates to a vehicle trim panel/radiator element combination and a vehicle trim panel/radiator element integral unit.

### BACKGROUND OF THE INVENTION

International Publication No. WO 97/09844 discloses a vehicle trim panel/radiator element combination, wherein the trim panel, a door lining 104, is molded from a plastic or fiberboard material. The lining 104 has a generally rectangular thin area, which receives a cellular core/inner skin combination. The thin rectangular door lining area and the cellular core/inner skin combination define a speaker radiator element. A transducer 9 is secured to the radiator element inner skin and functions to generate waves received by the element causing it to resonate and produce sound.

An improved vehicle trim panel is desired which includes a speaker radiator element, is lighter weight and less costly to manufacture.

### SUMMARY OF THE INVENTION

A first embodiment of the present invention provides a vehicle trim panel/radiator element integral unit, while a second embodiment provides a vehicle trim panel/radiator element combination. Both embodiments are believed to be lighter in weight and less costly to manufacture than prior art vehicle trim panel/radiator element combinations.

In accordance with a first aspect of the present invention, a vehicle trim panel/radiator element integral unit is provided. It comprises a multilayer substrate comprising a core layer and at least one outer layer. The substrate is formed so as to have a first region compressed to a first thickness and a second region having a second thickness, which is greater than the first thickness. The first region defines an audio speaker radiator element adapted to be energized or driven to produce sound and the second region is integral with the first region. Because the first and second regions are integral with one another and formed from the same substrate, fewer manufacturing steps are required to form the vehicle trim panel/radiator element integral unit and, hence, the cost of manufacturing the unit is reduced.

The substrate core layer may comprise at least one of a polymeric foam layer or sheet; a polymeric fiber non-woven mat, a mineral fiber non-woven mat and a mineral fiber/polymeric fiber non-woven mat.

The substrate outer layer may comprise at least one polymeric structure, and a non-woven mat structure. The polymeric structure is preferably formed from a material selected from the group consisting of polypropylene; polybutylene, polyhexane, polyoctene, polyester, polybutylene terephthalate (PBT); polypropylene terephthalate (PPT); polyphenylene sulfide; polyethylene terephthalate (PET); polyethylene; poly(α-olefin) polymers; polycarbonate, and mixtures thereof. The non-woven mat structure may comprise one or more of glass fibers, carbon fibers and cellulose fibers.

In a first embodiment, two outer layers are provided on opposing sides of the core layer. It is also contemplated that two or more outer layers may be provided on each side of the core layer.

The first thickness of the first region may be from about 0.25 mm to about 3 mm and the second thickness of the second region may be from about 0.8 mm to about 19 mm.

The vehicle trim panel/radiator element integral unit preferably further comprises a light fabric covering the first region and at least a first portion of the second region. A second material, such as a vinyl, leather or any other commonly used automotive covering material may cover a second portion of the second region.

In accordance with a second aspect of the present invention, a vehicle trim panel/radiator element combination is provided. It comprises a first substrate having at least one rib and at least one opening adjacent to the rib. The first substrate defines a vehicle interior trim panel. The combination further comprises a multi-layer second substrate comprising a core layer and at least one outer layer. The second substrate is located so as to extend at least partially over the opening in the first substrate, is secured to at least the first substrate rib, and defines an audio speaker radiator element adapted to be energized or driven to produce sound.

The first substrate may be formed from any one of the following materials: polypropylene; polybutylene, polyhexane, polyoctene, polyester, polybutylene terephthalate (PBT); polypropylene terephthalate (PPT); polyphenylene sulfide; polyethylene terephthalate (PET); polyethylene; or poly(α-olefin) polymers; or blends thereof. Fillers such as talc, exfoliated talc, mica and inorganics may be combined with any of these materials. The first substrate may also be formed from polycarbonate; acrylonitrile-butadiene styrene terpolymer (ABS), or styrene maleic anhydride copolymer (SMA); or natural fiber/polymer fiber blends of kenaf fibers/polypropylene fibers, flax fibers/polypropylene fibers, hemp fibers/polypropylene fibers or wood fibers/polypropylene fibers. The first substrate may have a thickness of from about 0.8 mm to about 19 mm.

The first substrate may comprise first and second ribs. The second substrate is preferably secured to the first and second ribs. Additional ribs may also be provided.

The core layer of the second substrate may comprise at least one of a polymeric foam layer; a polymeric fiber non-woven mat, a mineral fiber non-woven mat, or a mineral fiber/polymeric fiber non-woven mat.

The outer layer of the second substrate may comprise at least one polymeric structure, and a non-woven mat structure. The polymeric structure is preferably formed from a material selected from the group consisting of polypropylene; polybutylene, polyhexane, polyoctene, polyester, polybutylene terephthalate (PBT); polypropylene terephthalate (PPT); polyphenylene sulfide; polyethylene terephthalate (PET); polyethylene; poly(α-olefin) polymers; polycarbonate, and mixtures thereof. The non-woven mat structure may comprise one or more of glass fibers, carbon fibers and cellulose fibers.

In a first embodiment, the second substrate comprises two outer layers provided on opposing sides of the core layer. In an alternative embodiment, the second substrate comprises two outer layers provided on each side of the core layer.

The combination preferably further comprises a light fabric covering the second substrate and at least a first portion of the first substrate. A second material, such as a vinyl, leather or any other commonly used automotive covering material, preferably covers a second portion of the first substrate.

At least a portion of the second substrate has a thickness of from about 0.25 mm to about 3 mm.

### BRIEF DESCRIPTION OF THE DRAWING FIGURES

FIG. 1 is a perspective view of a vehicle trim panel/radiator element integral unit formed in accordance with a first embodiment of the present invention;

FIG. 2 is a view taken along view line 2-2 in FIG. 1;

FIG. 3 is an exploded, cross-sectional view of a multi-layer substrate from which the vehicle trim panel/radiator element integral unit illustrated in FIG. 1 may be formed;

FIG. 4A is a cross-sectional view of a first example of an outer layer which may form part of the multi-layer substrate illustrated in FIG. 3;

FIG. 4B is a cross-sectional view of a second example of an outer layer which may form part of the multi-layer substrate illustrated in FIG. 3;

FIG. 5A is a cross-sectional view of a third example of an outer layer which may form part of the multi-layer substrate illustrated in FIG. 3;

FIG. 5B is a cross-sectional view of a fourth example of an outer layer which may form part of the multi-layer substrate illustrated in FIG. 3;

FIGS. 6A and 6B are partially schematic, partially cross-sectional views of the cold molding process used to form the vehicle trim panel/radiator element integral unit of the present invention;

FIG. 7 is an exploded, cross-sectional view of a multi-layer substrate formed in accordance with another embodiment of the present invention from which the vehicle trim panel/radiator element integral unit illustrated in FIG. 1 may be formed;

FIG. 8 is a plan view of a headliner formed in accordance with the present invention;

FIG. 9 is a perspective view of a vehicle trim panel/radiator element combination formed in accordance with a second embodiment of the present invention; and

FIG. 10 is a view taken along view line 10-10 in FIG. 9.

### DETAILED DESCRIPTION AND PREFERRED EMBODIMENTS OF THE INVENTION

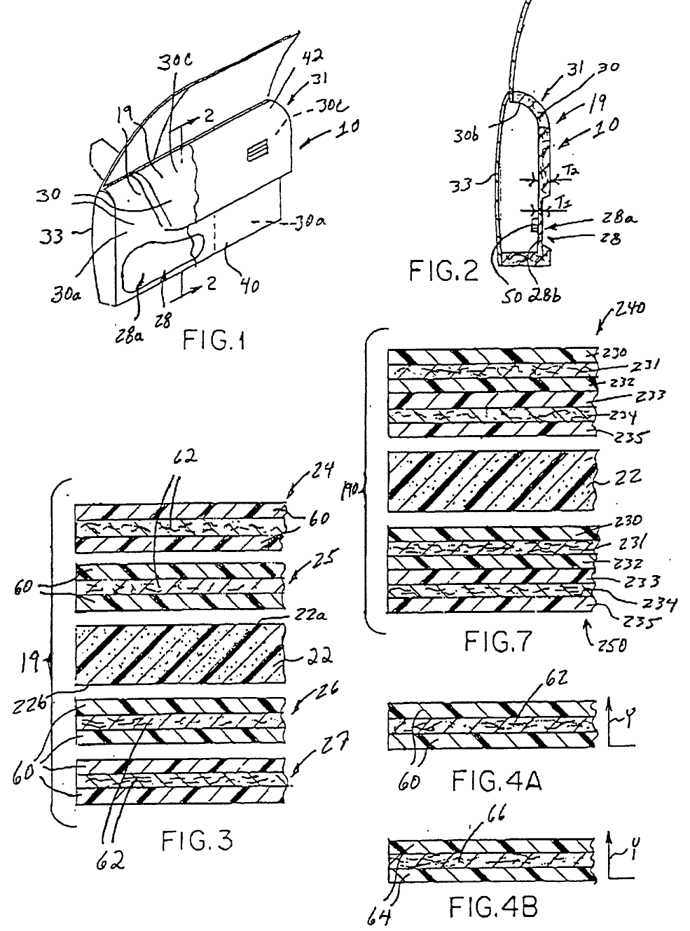

Reference is now made to FIGS. 1 and 2, where a vehicle trim panel/radiator element integral unit 10 is illustrated. It comprises a multi-layer substrate 19, which, in a first embodiment, comprises a core layer 22 and first, second, third and fourth outer layers 24-27, see FIG. 3. The first and second outer layers 24 and 25 are positioned on a first side 22a of the core layer 22 while the third and fourth outer layers 26 and 27 are positioned on a second side 22b of the core layer 22.

The substrate 19 is molded so as to have a first region 28 compressed to a first thickness T₁ of from about 0.25 mm to about 3 mm and a second region 30 having a second thickness T₂ of from about 0.8 mm to about 19 mm, see FIG. 2. The first region 28 defines a radiator element 28a and is integral with the second region 30. The second region 30 defines a vehicle trim panel, a door panel 31 in the illustrated embodiment. As illustrated in FIGS. 1 and 2, the door panel 31 is intended to be coupled to a metal vehicle doorframe 33.

A conventional electro-mechanical drive device 50, such as a transducer, is coupled to the radiator element 28a, see FIG. 2. A thermoset adhesive, examples of which are commercially available from 3M Corporation under the product designations “JetWeld,” and “3M 8105,” or other like adhesive, may be used to secure the device 50 to a backside 28b (i.e., so as to face away from the passenger compartment) of the radiator element 28a. If desired, positioning of the drive device 50 on the radiator element 28a may be effected using conventional scanning laser vibrometry so as to minimize panel modal distortions and create uniform modal density of sound emanating in all directions. The drive device 50 may comprise any one of the drive devices disclosed in U.S. Pat. Nos. 6,151,402 and 6,192,136, the disclosures of which are incorporated herein by reference. The drive device 50 is driven by a signal amplifier (not shown), such as an audio amplifier. The device 50 functions to drive or energize the radiator element 28a to produce sound, i.e., device 50 encourages the radiator element 28a to produce a maximum number of bending resonance frequencies substantially evenly distributed in frequency resulting in complex random motion and producing non-directional sound. Hence, the radiator element 28a and the drive device 50 define a loudspeaker for generating music and like sounds within a passenger compartment of a vehicle. It is also contemplated that the drive device 50 may comprise a device which is commercially available from ELAC GmbH under the product designation “ELAC 82073” with a voice coil diameter of 37 mm.

The integral unit 10 further comprises a light fabric 40 (shown in FIG. 1 but not shown in FIG. 2) covering the first radiator element 28a and a first portion 30a of the second region 30. The light fabric 40 may comprise a polyester knit fabric or an antipilling microfiber fabric, both of which are commercially available from Glen Raven Inc., Majestex Corp. and Timmel Corp. It is wrapped so as to extend onto a backside 30b of the second region 30 and is secured thereto via heat stakes. A conventional vinyl or leather layer 42 may be used to cover the remaining, second portion 30c of the second region 30. A seam 15 defines where the fabric 40 meets the vinyl or leather 42.

Referring now to FIG. 3, the core layer 22 may comprise a semi-rigid polyurethane open cell foam sheet, preferably having open cells equal to or greater than 30%, a compression force displacement greater than 3 Newtons, a flexural strength greater than or equal to about 70 kilopascals, a thickness of from about 1 mm to about 25 mm and preferably about 3 mm and a density of from about 2 to about 5 pounds/ft³, examples of which are commercially available from Woodbridge Foam Group under the trade designation “RT2015” or “RT2525” and Foamex International under the trade designation “Custom Fit.” The core layer 22 may also comprise a polypropylene foam sheet preferably having open cells equal to or greater than 30%, a compression force displacement greater than 3 Newtons, a flexural strength greater than or equal to about 70 kilopascals, a thickness of from about 5 mm to about 30 mm and a density of from about 0.25 to about 2.0 pounds/ft³, examples of which are commercially available from Fagerdala World Foam Group Inc. under the trade designation “Fawotop 200”; and EPE Inc. under the trade designation “EPE Perfed Foam.

The core layer 22 may further comprise a polymeric non-woven mat based on polyethylene, polypropylene, and/or polyester fibers. The mat preferably has a density of from about 50 grams/m² to about 500 grams/m², an uncompressed thickness of from about 5 mm to about 50 mm, and a fiber diameter of from about 0.5 denier to about 50 denier. An example polymeric non-woven mat comprises a thickness of 15 mm, a density of 500 grams/meter², is formed from polyester fibers and is commercially available from Vita Polymer Group Inc. under the trade designation “QW500.”

The core layer 22 may still further comprise a non-woven mineral fiber mat having a thickness of from about 10 mm to about 30 mm, a density of from about 500 grams/meter² to about 1500 grams/meter², glass fibers in an amount from about 80% to about 95% by weight, based on the total weight of the mat, and a binder, e.g., phenolic, in an amount of from about 5% to about 20% by weight, based on the total weight of the mat, and is commercially available from Owens Corning under the trade designation “Molding Media.”

The core layer 22 may additionally comprise a non-woven glass or carbon fiber/polymeric fiber mat having a thickness of from about 5 mm to about 35 mm, a density of from about 500 grams/meter² to about 1500 grams/meter², comprises polyethylene fibers, polypropylene fibers, polyester fibers, or polyamide fibers or blends thereof in an amount from about 50% to about 90% by weight, based on the total weight of the mat, and glass fibers (A, C, AF or bi-component fibers) or carbon fibers (carbon or pitch carbon) in an amount from about 10% to about 50% by weight, based on the total weight of the mat. One such mat comprises a non-woven glass fiber/polymeric fiber mat having a thickness of 25 mm, a density of about 1250 grams/meter², comprises polymer fibers in an amount of about 70% by weight, based on the total weight of the mat, and glass fibers in an amount of about 30% by weight, based on the total weight of the mat, and is commercially available from Owens Coming under the trade designation “Versamat 3000.”

Each first, second, third and fourth outer layer 24-27 may comprise outer or intermediate structures comprising a polymeric layer or coating and a non-woven mat. The polymeric layers or coatings may be formed from any one of the materials polypropylene; polybutylene, polyhexane, polyoctene, polyester, polybutylene terephthalate (PBT); polypropylene terephthalate (PPT); polyphenylene sulfide; polyethylene terephthalate (PET); polyethylene; poly(α-olefin) polymers; or polycarbonate, or mixtures thereof, and have a thickness of from about 0.01 mm to about 0.1 mm. The non-woven mats defining the outer or intermediate structures may comprise glass, carbon or cellulose fibers held together via a thermoplastic binder or a moldable Bstageable binder, have a density of from about 5 grams/m² to about 200 grams/m² and a thickness of from about 0.1 mm to about 5 mm.

A first example of a non-woven mat which may be incorporated into an outer layer 24-27 comprises a glass veil having a thickness of from about 0.1 mm to about 5 mm, a density of from about 5 grams/m² to about 50 grams/m², comprises glass fibers in an amount from about 80% to about 95% by weight, based on the total weight of the veil, and a binder in an amount of from about 5% to about 20% by weight, based on the total weight of the veil. The binder comprises a thermoplastic binder such as acrylic, acetate, vinyl acetate, or an olefin copolymer or blends thereof, or a thermoset binder such as a hybrid acrylic, an epoxy, a urethane, or acrylic-epoxy or blends thereof. The veil is commercially available from Owens Coming under the trade designations “M524 Veil”; “C33 Veil”; “OC1530”; “OC1560”; and “OC1570.” Similar veils are commercially available from Johns Manville Corp. under the product designations “Elasti Glass 3000,” “Elasti Glass 8300,” “Elasti Glass 8400,” “Elasti Glass 8900,” “Elasti Glass 5000.”

A second example of the non-woven mat comprises a carbon fiber mat having a thickness of from about 0.1 mm to about 5 mm, a density of from about 15 grams/m² to about 50 grams/m², comprises carbon fibers in an amount from about 80% to about 95% by weight, based on the total weight of the mat, and a binder in an amount of from about 5% to about 20% by weight, based on the total weight of the mat. The binder comprises a thermoplastic binder such as acrylic, acetate, vinyl acetate, or an olefin copolymer or blends thereof, or a thermoset binder such as a hybrid acrylic, an epoxy, a urethane, or acrylic-epoxy or blends thereof. The carbon fiber mat is commercially available from Technical Fibres Inc. under the trade designation “Optimat T2000.”

A third example of the non-woven mat comprises a cellulose fiber mat having a thickness of from about 0.1 mm to about 5 mm, a density of from about 50 grams/m² to about 200 grams/m², comprises cellulose fibers in an amount from about 95% to about 99% by weight, based on the total weight of the mat, and a binder in an amount of from about 1% to about 5% by weight, based on the total weight of the mat. The binder comprises a vinyl acetate or a thermoplastic emulsion copolymer. An example cellulose fiber mat is commercially available from Reich Paper Inc. under the trade designation “Trans-Weave.” Other examples of cellulose fiber mats include those commercially available from International Paper Corporation under the trade designations “Kraft 50 grams/m²”; “Kraft 200 grams/m²”; and “Kraft 10#.”

A first example of an outer layer 24-27 is illustrated in FIGS. 3 and 4A and is commercially available from Frantschach GmbH under the product designation “80509.” It comprises outer layers or structures 60 formed from polyethylene, each having a thickness in the Y direction of about 0.02 mm to about 0.05 mm and a density of about 40 grams/m², and an intermediate layer or structure 62 comprising either a glass veil discussed above such as one which is commercially available from Owens Corning under the trade designation “OC 1560,” or the carbon fiber mat discussed above and which is commercially available from Technical Fibres Inc. under the trade designation “Optimat T2000.” The intermediate layer 62 preferably has a thickness in the Y direction of 0.5 mm and a density of about 50 grams/m².

A second example of an outer layer 24-27 is illustrated in FIG. 4B and is commercially available from Frantschach GmbH under the product designation “P3907.” It comprises outer skin layers or structures 64 formed from polypropylene, each having a thickness in the Y direction of from about 0.01 mm to about 0.05 mm and a density of about 45 grams/m², and an intermediate layer or structure 66 comprising either a glass veil discussed above such as one which is commercially available from Owens Corning under the trade designation “OC 1530,” or the carbon fiber mat discussed above and which is commercially available from Technical Fibres Inc. under the trade designation “Optimat T2000.” The intermediate layer 66 preferably has a thickness in the Y direction of 1.0 mm and a density of about 90 grams/m².

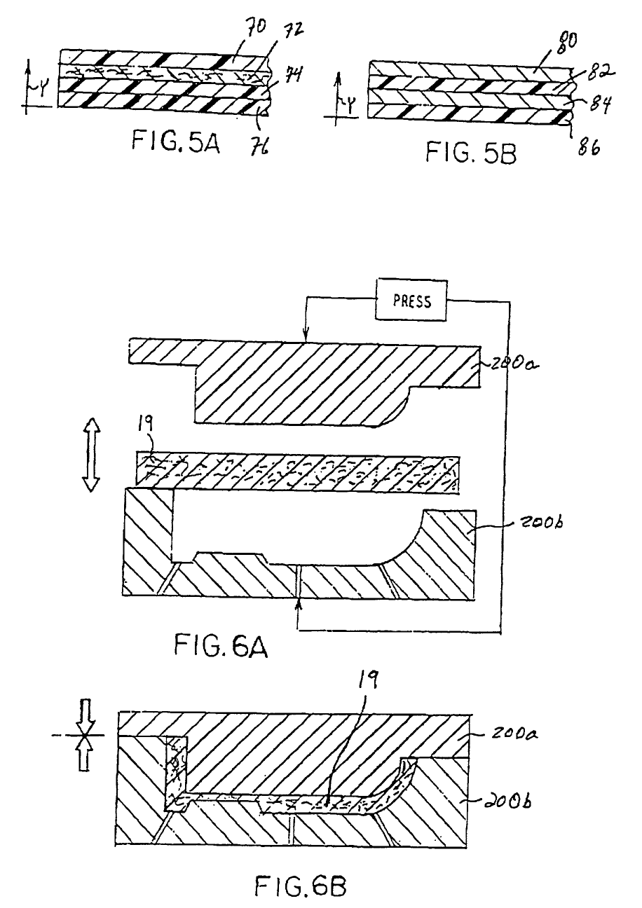

A third example of an outer layer 24-27 is illustrated in FIG. 5A and is commercially available from Frantschach GmbH under the product designation “81385.” It comprises the following layers or structures: a first polyethylene layer or coating 70, having a thickness in the Y direction of about 0.01 mm to about 0.05 mm and a density of about 40 grams/m²; a second layer 72 comprising a glass veil discussed above such as one which is commercially available from Owens Corning under the trade designation “OC 1570”; a third polyethylene coating or layer 74, having a thickness in the Y direction of about 0.01 mm to about 0.05 mm and a density of about 45 grams/m²; and a fourth polyester coating or layer 76, having a thickness in the Y direction of about about 0.1 mm and a density of about 70 grams/m². The second layer 72 preferably has a thickness in the Y direction of from about 0.1 mm to about 0.5 mm and a density of about 50 grams/m².

A fourth example of an outer layer 24-27 is illustrated in FIG. 5B and is commercially available from Frantschach GmbH under the product designation “90310.” It comprises the following layers or structures: a first layer 80 comprising the cellulose paper fiber layer discussed above and which is commercially available from International Paper Company under the trade designation “Kraft 50 grams/m²”; a second polyethylene coating or layer 82, having a thickness in the Y direction of about 0.05 mm, and density of about 46 grams/m²; a third layer 84 comprising the cellulose paper fiber layer discussed above and which is commercially available from International Paper Company under the trade designation “Kraft 10#”; and a fourth polyethylene coating or layer 86, having a thickness in the Y direction of about 0.03 mm and a density of about 28 grams/m². The first layer 80 may have a thickness of about 0.5 mm and a density of about 50 grams/m², while the third layer 84 may have a thickness in the Y direction of about 0.4 mm and a density of about 200 grams/m².

It is also contemplated that each of outer layers 24-27 may alternatively comprise a natural vellum paper (100% cellulose fibers), one of which is commercially available from Reich Paper Inc. under the trade designation “Vellum 17#” or “Vellum 24#.” It is further contemplated that each of the outer layers 24-27 may comprise an acrylic or melamine resin impregnated cellulosic paper, one of which is commercially available from Rex-el Inc. under the product designation “General Purpose Grade Panel Art HP Decorative Laminate,” and having a thickness of from about 0.020 inch to about 0.050 inch. It is still further contemplated that each of the outer layers 24-27 may comprise a wood based or composite veneer product, examples of which are commercially available from Oakwood Veneer Co., under the product designation “Bubble Free Veneer,” having a thickness of from about 1 mm to about 3 mm, and from Wilson Art Inc. under the product designation “7885T”.

To form the vehicle trim panel/radiator element integral unit 10 the core layer 22 and the first, second, third and fourth outer layers 24-27 are positioned relative to one another as illustrated in FIG. 3, such that the first and second layers 24 and 25 are located on the first side 22a of the core layer 22 and the third and fourth layers 26 and 27 are positioned on a second side 22b of the core layer 22. The combined layers 22 and 24-27 are then placed between a pair of heated belts (not shown), heated to a temperature of about 350 degrees F., and remain between the belts for approximately 60 seconds. A plurality of sets of heated rolls may be provided in place of the heated belts. In addition to applying heat to the layers 22 and 24-27, the belts also apply a slight pressure causing the layers 22 and 24-27 to bond or laminate to one another so as to form a laminate 19 (also referred to herein as the multi-layer substrate 19), see FIG. 6A. At this juncture, the laminate 19 may have a thickness of from about 5 mm to about 30 mm. This resulting laminate 19 may then be stored for later use, or forwarded for further immediate in-line processing.

In accordance with the present invention, the laminate 19 is compressed or molded via a conventional compression or molding process so as to form the integral unit 10. Prior to molding, the laminate 19 is heated to temperature of about 350 degrees F. to make it soft, pliable, and susceptible to molding. This can be done by passing the laminate 19 through a warming device, such as an infrared or convection oven (not shown). The warmed laminate 19 is then placed between cold opposing dies 200a, 200b (i.e., at a temperature of from about 40 degrees F. to about 60 degrees F.) in a mold, see FIGS. 6A and 6B, or other cold shaping tool. The dies 200a, 200b are capable of moving relative to each other between open (FIG. 6A) and closed (FIG. 6B) positions (see action arrows in FIGS. 6A and 6B). Each mold half is connected to a hydraulic or pneumatic press or like motive device capable of moving these halves, and hence, the dies 200a, 200b towards each other.

When the dies 200a, 200b are brought together by the press, the laminate 19 is thus compressed or compacted in a first section to a first thickness T₁ of from about 0.25 mm to about 3 mm so as to form the first region 28, yet is preferably only compressed in a second section to a second thickness T₂ of from about 0.8 mm to about 19 mm so as to form the second region 30. The compressed laminate 19 along with fabric layer 40 and vinyl or leather layer 42 comprise the integral unit 10.

A multi-layer substrate 190, formed in accordance with a second embodiment of the present invention and adapted to be used to form a vehicle trim panel/radiator element integral unit, is illustrated in FIG. 7, where like reference numerals indicate like elements. The substrate 190 comprises a core layer 22 and first and second outer layers 240 and 250. Only a single outer layer 240 or 250 is provided on each side of the core layer 22. The first and second outer layers 240 and 250 are preferably of a greater thickness than any one of outer layers 24-27 of the FIG. 3 embodiment so as to give the substrate 190 and resulting vehicle trim panel/radiator element integral unit sufficient strength. For example, each outer layer 240 and 250 may comprise six layers such as first, third, fourth and sixth layers 230, 232, 233 and 235 formed from polyethylene and having the same density and thickness as each polyethylene layer in the FIG. 4A embodiment and further comprise second and fifth glass veil or carbon fiber mat layers 231 and 234, which are of the same density and thickness as the glass veil or carbon fiber mat layer in the FIG. 4A embodiment.

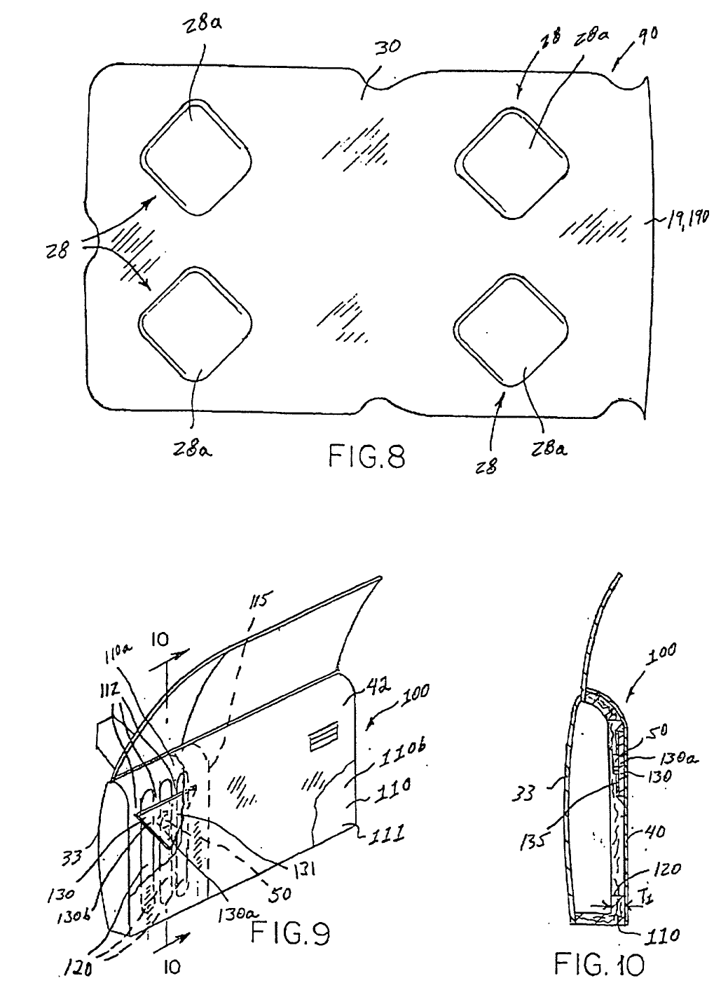

The substrate 19 or 190 may also be formed of a size sufficient to allow it to be molded into a headliner 90, see FIG. 8, or other vehicle component, such as a trunk liner (not shown). The headliner 90 is molded so as to have at least one first region 28 having a first thickness T₁ and defining a radiator element 28a and a second region 30 having a second thickness T₂, which is greater than the first thickness T₁. The first region(s) 28 defines a radiator element 28a and the second region 30 is integral with the first region 28. A drive device 50 is coupled to each radiator element 28a.

Referring now to FIGS. 9 and 10, where like elements are referenced by like reference numerals, a vehicle trim panel/radiator element combination 100 is illustrated. It comprises a first substrate 110 comprising at least one support rib 112, three in the illustrated embodiment, and at least one opening 120, three in the illustrated embodiment, positioned adjacent to a support rib 112. The first substrate 110 may be formed polypropylene; polybutylene, polyhexane, polyoctene, polyester, polybutylene terephthalate (PBT); polypropylene terephthalate (PPT); polyphenylene sulfide; polyethylene terephthalate (PET); polyethylene; or poly(α-olefin) polymers; or blends thereof. Fillers such as talc, exfoliated talc, mica and inorganics may be combined with any of these materials. The first substrate 110 may also be formed from polycarbonate; acrylonitrile-butadiene styrene terpolymer (ABS), styrene maleic anhydride copolymer (SMA), or natural fiber/polymer fiber blends such as blends of kenaf fibers/polypropylene fibers, flax fibers/polypropylene fibers, hemp fibers/polypropylene fibers or wood fibers/polypropylene fibers.

The first substrate 110 is molded in a conventional injection molding apparatus or compression press (not shown) so as to define a vehicle interior trim panel, a door panel 111 in the illustrated embodiment. As illustrated in FIG. 9, the door panel 111 is intended to be coupled to a metal vehicle doorframe 33. The first substrate 110 including the ribs 112 has a thickness and density which are generally constant throughout its length and width. In particular, the thickness T₁ is from about 2 mm to about 4 mm and the density is from about 1.1 grams/cm³ to about 1.5 grams/cm³. The first substrate 110 may also be formed into a headliner, a trunk liner, or other vehicle trim panel.

The combination 100 further comprises a multi-layer second substrate 130, which is formed from the same materials and in the same manner as substrate 19 or substrate 190 discussed above. The second substrate 130 is compressed in a conventional compression mold such that at least a center portion 130a has a thickness of from about 0.25 mm to about 3 mm. The surrounding outer edge portion 130b of the second substrate 130 may have a thickness of from about 0.8 mm to about 19 mm. The center portion 130a defines a speaker radiator element 131.

A conventional electro-mechanical drive device 50, such as described above, is adhesively coupled to the radiator element 131, see FIG. 9. As noted above, the device 50 functions to generate waves received by the radiator element 131 causing the element 131 to resonate and produce sound. Hence, the radiator element 131 and the drive device 50 define a loudspeaker for generating music and like sounds within a passenger compartment of a vehicle.

The second substrate 130 is preferably coupled to each of the support ribs 112 via adhesive-backed foam strips 135, which are commercially available from Tesa Tape Inc., under the product designation “Tesa 4965.” The second substrate 130 is preferably positioned over the openings 120. By providing support ribs 112 separated by openings 120, the first substrate is lighter and less costly to manufacture than prior art door liners. Further, it is believe that the acoustical performance of the speaker radiator element 131 is improved as the element contacts less surface area of the first substrate 110.

The combination 100 further comprises a light fabric 40 covering the second substrate 130 and at least a first portion 110a of the first substrate 110. The light fabric 40 is wrapped so as to extend onto a backside of the second substrate 130 and is secured thereto via heat staking. A conventional vinyl or leather layer 42 may be used to cover the remaining, second portion 110b of the first substrate 110. A seam 115 defines where the fabric 40 meets the vinyl or leather 42.

Obvious modifications are also possible in light of the teachings provided above. For example, the speaker radiator elements may have a non-planar shape. That is, when viewed in cross section or from any one of its sides, the radiator elements may have a curvilinear profile.

The foregoing description of the present invention has been presented for purposes of illustration and description. It is not intended to be exhaustive or to limit the invention to the precise form disclosed. Obvious modifications or variations are possible in light of the above teachings. The embodiments described were chosen to provide a general illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

In the claims:

1. A vehicle trim panel/radiator element integral unit comprising:
a multi-layer substrate comprising a core layer and at least one outer layer, said substrate being formed so as to have a first region compressed to a first thickness and a second region having a second thickness which is greater than said first thickness, said first region defining an audio speaker radiator element, and said second region being integral with said first region.

2. A vehicle trim panel/radiator element integral unit as set out in claim 1, wherein said substrate core layer comprises at least one of a polymeric foam layer; a polymeric fiber non-woven mat, a mineral fiber non-woven mat, and a mineral fiber/polymeric fiber non-woven mat.

3. A vehicle trim panel/radiator element integral unit as set out in claim 1, wherein said substrate outer layer comprises:
at least one polymeric structure; and
a non-woven mat structure.

4. A vehicle trim panel/radiator element integral unit as set out in claim 3, wherein said non-woven mat structure may comprise one or more of glass fibers, carbon fibers and cellulose fibers.

5. A vehicle trim panel/radiator element integral unit as set out in claim 4, wherein said substrate comprises two outer layers provided on opposing sides of said core layer.

6. A vehicle trim panel/radiator element integral unit as set out in claim 4, wherein said substrate comprises two outer layers provided on each side of said core layer.

7. A vehicle trim panel/radiator element integral unit as set out in claim, 1 wherein said first thickness of said first region is from about 0.25 mm to about 3 mm and said second thickness of said second region is from about 0.8 mm to about 19 mm.

8. A vehicle trim panel/radiator element integral unit as set out in claim 1, further comprising a light fabric covering said first region and at least a first portion of said second region.

9. A vehicle trim panel/radiator element integral unit as set out in claim 8, wherein a second material covers a second portion of said second region.

10. A vehicle trim panel/radiator element integral unit as set out in claim 9, wherein said second material comprises one of vinyl and leather.

11. A vehicle trim panel/radiator element integral unit as set out in claim 1, wherein s aid integral unit comprises a vehicle interior door panel.

12. A vehicle trim panel/radiator element combination compris ing:
a first substrate having at least one rib and at least one opening adjacent to said rib, said first substrate defining a vehicle interior trim panel; and
a multi-layer second substrate comprising a core layer and at least one outer layer, said second substrate being located so as to extend at least partially over said opening, is secured to at least said first substrate rib, and defines an audio speaker radiator element.

13. A vehicle trim panel/radiator element combination as set out in claim 12, wherein said first substrate comprises first and second ribs, and said second layer is secured to said first and second ribs.

14. A vehicle trim panel/radiator element combination as set out in claim 13, wherein said core layer of said second substrate comprises at least one of a polymeric foam layer; a polymeric fiber non-woven mat, a mineral fiber non-woven mat and a mineral fiber/polymeric fiber non-woven mat.

15. A vehicle trim panel/radiator element combination as set out in claim 14, wherein said outer layer of said second substrate comprises:
at least one polymeric structure; and
a non-woven mat structure.

16. A vehicle trim panel/radiator element combination as set out in claim 15, wherein said non-woven mat structure comprises one or more of glass fibers, carbon fibers and cellulose fibers.

17. A vehicle trim panel/radiator element combination as set out in claim 16, wherein said second substrate comprises two outer layers provided on opposing sides of said core layer.

18. A vehicle trim panel/radiator element combination as set out in claim 16, wherein said second substrate comprises two outer layers provided on each side of said core layer.

19. A vehicle trim panel/radiator element combination as set out in claim 12, further comprising a light fabric covering said second substrate and at least a first portion of said first substrate.

20. A vehicle trim panel/radiator element combination as set out in claim 19, wherein a second material covers a second portion of said first substrate.

21. A vehicle trim panel/radiator element combination as set out in claim 20, wherein said second material comprises vinyl or leather.

22. A vehicle trim panel/radiator element combination as set out in claim 12, wherein said first substrate has a thickness of from about 0.8 mm to about 19 mm.

23. A vehicle trim panel/radiator element combination as set out in claim 22, wherein said second substrate has a thickness of from about 0.25 mm to about 3 mm.
